(19) United States
(12) Patent Application Publication
(10) Pub. No.: US 2026/0336377 A1
(43) Pub. Date: Oct. 29, 2026

(54) ENGINE SUPPORT FOR A UTILITY VEHICLE

(71) Applicant: DEERE & COMPANY, MOLINE, IL (US)

(72) Inventors: Martin Walser, Heidelberg (DE); Norbert Groessbrink, Mannheim (DE); Thorsten Thomassik, Mannheim (DE)

(21) Appl. No.: 19/632,939

(22) Filed: Mar. 30, 2026

(30) Foreign Application Priority Data
Apr. 24, 2025 (EP) 25172347.4

(51) Int. Cl. B60K 5/12; F01M 11/00

(52) U.S. Cl. CPC B60K 5/1216; F01M 11/0004; F01M 2011/0054

(57) ABSTRACT

An engine support for a utility vehicle includes a sandwich plate mountable on a load-bearing vehicle structure and having an upper fastening interface for liquid-tight attachment of a separating surface formed on an engine block and a lower fastening interface situated opposite the upper fastening interface for liquid-tight attachment of a separating surface formed on an oil pan, the sandwich plate including at least one aperture for producing a lubricant connection between the oil pan and the engine block.

### CROSS-REFERENCE TO RELATED APPLICATIONS

This application claims priority to European Patent Application No. 25172347.4, filed Apr. 24, 2025, which is hereby incorporated by reference.

### FIELD OF THE DISCLOSURE

The disclosure relates to an engine support for a utility vehicle, for example an agricultural tractor.

### BACKGROUND

Engine supports of said type serve for the fastening of an internal combustion engine, normally in the form of a diesel engine in utility vehicles, to a load-bearing vehicle structure.

### SUMMARY

According to an aspect of the present disclosure, an engine support for a utility vehicle includes a sandwich plate mountable on a load-bearing vehicle structure and having an upper fastening interface for liquid-tight attachment of a separating surface formed on an engine block and a lower fastening interface situated opposite the upper fastening interface for liquid-tight attachment of a separating surface formed on an oil pan, the sandwich plate including at least one aperture for producing a lubricant connection between the oil pan and the engine block.

According to an aspect of the present disclosure, the upper fastening interface includes an upper abutment surface bordering the at least one aperture and the lower fastening interface includes a lower abutment surface bordering the at least one aperture, the upper and lower abutment surfaces include a plurality of threaded bores for attachment of the engine block and the oil pan.

According to an aspect of the present disclosure, the upper and lower abutment surfaces have profiles which differ from one another.

According to an aspect of the present disclosure, the at least one aperture includes a plurality of apertures forming a web-like structure.

According to an aspect of the present disclosure, the web-like structure has a plurality of reinforced connecting ribs.

According to an aspect of the present disclosure, the sandwich plate includes first and second lateral bearing surfaces situated on opposite longitudinal sides of the sandwich plate for mounting on a load-bearing vehicle structure.

According to an aspect of the present disclosure, the sandwich plate is a cast plate.

According to an aspect of the present disclosure, an engine structural unit includes a sandwich plate mountable on a load-bearing vehicle structure and having an upper fastening interface and a lower fastening interface situated opposite the upper fastening interface, an engine block having a separating surface in liquid-tight attachment to the upper fastening interface, and an oil pan having a separating surface in liquid-tight attachment to the lower fastening interface, the sandwich plate including at least one aperture for producing a lubricant connection between the oil pan and the engine block.

The above and other features will become apparent from the following detailed description and accompanying drawings.

### BRIEF DESCRIPTION OF THE DRAWINGS

The engine support according to the disclosure for a utility vehicle, for example an agricultural tractor, will be discussed in more detail below on the basis of the appended drawings. Here, components or assemblies with an equivalent or comparable function are denoted by the same reference signs. In the drawings:

FIG. 1 shows a perspective view of an example embodiment of the engine support according to the disclosure in the form of a sandwich plate;

FIG. 2 shows a lateral plan view of the sandwich plate shown in FIG. 1;

FIG. 3 shows a plan view of a top side of the sandwich plate shown in FIG. 1;

FIG. 4 shows a plan view of a bottom side of the sandwich plate shown in FIG. 1;

FIG. 5 shows an exploded illustration of an engine structural unit comprising the sandwich plate as per FIG. 1 and having an engine block and oil pan for attachment to a load-bearing vehicle structure;

FIG. 6 shows the engine structural unit illustrated in FIG. 5 in an assembled state;

FIG. 7 shows a plan view of the top side of the sandwich plate shown in FIG. 1 with an engine block attached thereto and oil pan attached thereto; and

FIG. 8 shows a plan view of the bottom side of the sandwich plate shown in FIG. 1 with an oil pan attached thereto.

### DETAILED DESCRIPTION

The embodiments or implementations disclosed in the above drawings and the following detailed description are not intended to be exhaustive or to limit the present disclosure to these embodiments or implementations.

In this case, the diesel engine includes an engine block and an oil pan which is flange-mounted on the bottom side thereof. The oil pan forms a reservoir for oil, which serves for lubricating the movable engine components thereabove within the engine block. The engine supports are normally holding brackets attached to the surrounding vehicle structure by means of rubber bearings. The rubber bearings result in a relatively soft suspension of the diesel engine and consequently in correspondingly low natural frequencies in the range from 20 to 30 Hz, which can be manifested in the form of perceptible vibrations of the utility vehicle. Furthermore, structural loads acting on the engine block, but also torsional moments occurring along the engine block for drive-related reasons, act directly on the oil pan that is flange-mounted thereon. This places correspondingly high demands on the screw connection of the engine block and the oil pan or the tightness thereof.

It is therefore an object of the present disclosure to specify an engine support for a utility vehicle, for example an agricultural tractor, which is improved in view of the above-described circumstances.

This object is achieved by an engine support having the features of one or more embodiments disclosed herein.

The engine support according to the disclosure for a utility vehicle, for example an agricultural tractor, comprises a sandwich plate which is mountable on a load-bearing vehicle structure and which has an upper fastening interface for liquid-tight attachment of a separating surface formed on an engine block, and which has a lower fastening interface, situated opposite the upper fastening interface, for liquid-tight attachment of a separating surface formed on an oil pan, wherein provision is made in the sandwich plate of at least one aperture for producing a lubricant connection between the oil pan and the engine block.

The sandwich plate serves as a “buffer” within the load-bearing vehicle structure and keeps the structural loads acting thereon away from the engine block and the oil pan. The engine structural unit formed together with the oil pan is, in combination with the load-bearing vehicle structure, moreover particularly resistant to torsion on account of its box-like cross section, which is beneficial in relation to tightness in the case of torsional moments occurring along the engine block for drive-related reasons. The attachment to the surrounding load-bearing vehicle structure can be realized rigidly (that is to say without the customary rubber bearings), whereby the natural frequencies of the engine structural unit can be increased into non-critical ranges. The use of the sandwich plate as an intermediate element moreover provides additional freedom with regard to the shaping of the engine block, the oil pan, and the load-bearing vehicle structure.

The engine support or the sandwich plate forms together with an engine block attached to the upper fastening interface and an oil pan attached to the lower fastening interface a self-contained, moreover particularly compact and rigid, engine structural unit. This can be pre-assembled, checked for tightness and correct functioning, and then installed into the utility vehicle.

Advantageous refinements of the engine support according to the disclosure emerge from one or more embodiments disclosed herein.

According to some embodiments, the upper and/or lower fastening interface is an abutment surface which borders the at least one aperture and which is extended through by a multiplicity of threaded and/or passage bores for attachment of the engine block and/or of the oil pan. The threaded and passage bores serve for screwing of the engine block and the oil pan to the sandwich plate, or the oil pan to the engine block through the sandwich plate, by means of associated bolts.

In the assembled state, seals provided between the abutment and separating surfaces of the engine block and of the oil pan prevent escape along the abutment or separating surfaces and also the threaded and/or passage bores. The threaded and/or passage bores may be formed within the respective abutment surface in the form of a ring running around the at least one aperture.

Furthermore, the abutment surfaces may have profiles which differ from one another. This makes it possible to select separating surfaces for the engine block and the oil pan that have different profiles, which in turn makes it possible to optimize the dimensions of the oil pan independently of the dimensions of the engine block situated thereabove in terms of length and width in the context of accommodating the greatest possible oil volume. In conventional arrangements, in which the engine block and the oil pan are flange-mounted directly on one another and therefore necessarily have separating surfaces with identical profiles, such a possibility naturally does not exist.

The torsional stiffness of the sandwich plate can be increased while simultaneously saving on material and weight if provision is made of a multiplicity of apertures which form a web-like structure or are stiffened by a web-like structure.

Here, the web-like structure may have a multiplicity of reinforced connecting ribs. For reinforcement purposes, bead-like thickened portions may be formed along the connecting ribs.

Furthermore, it is possible that the sandwich plate opens out into lateral bearing surfaces for mounting on a load-bearing vehicle structure. The lateral bearing surfaces are associated with the longitudinal sides of the sandwich plate, such that the sandwich plate ultimately forms a connecting bridge between opposite side portions of the load-bearing vehicle structure. In the case of a utility vehicle in the form of an agricultural tractor, asymmetrical force influences which affect the load-bearing vehicle structure for example during the operation of a front power lift can be compensated in this way.

The sandwich plate is generally a cast plate. The abutment or bearing surfaces are formed here by regions that are face-milled at a later stage. However, it may, by contrast, also be a CNC-machined rolled-steel plate.

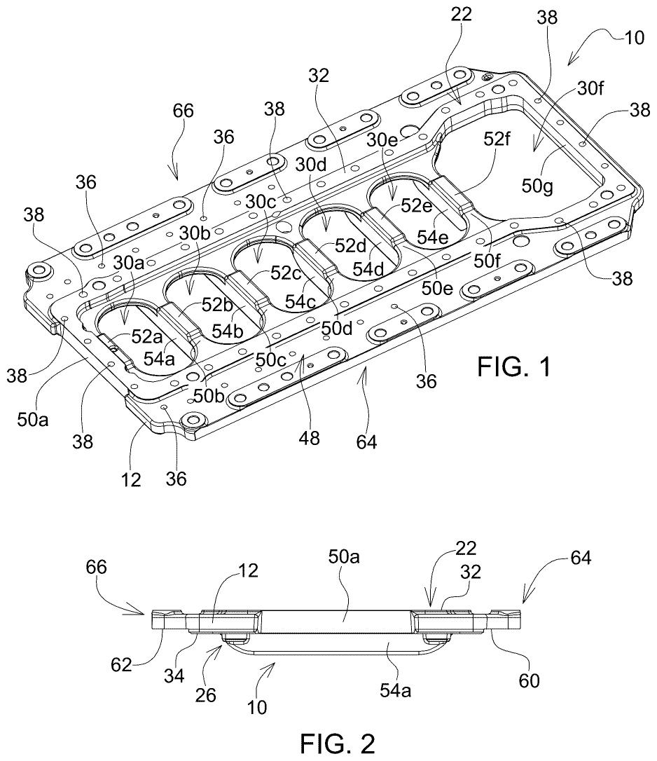

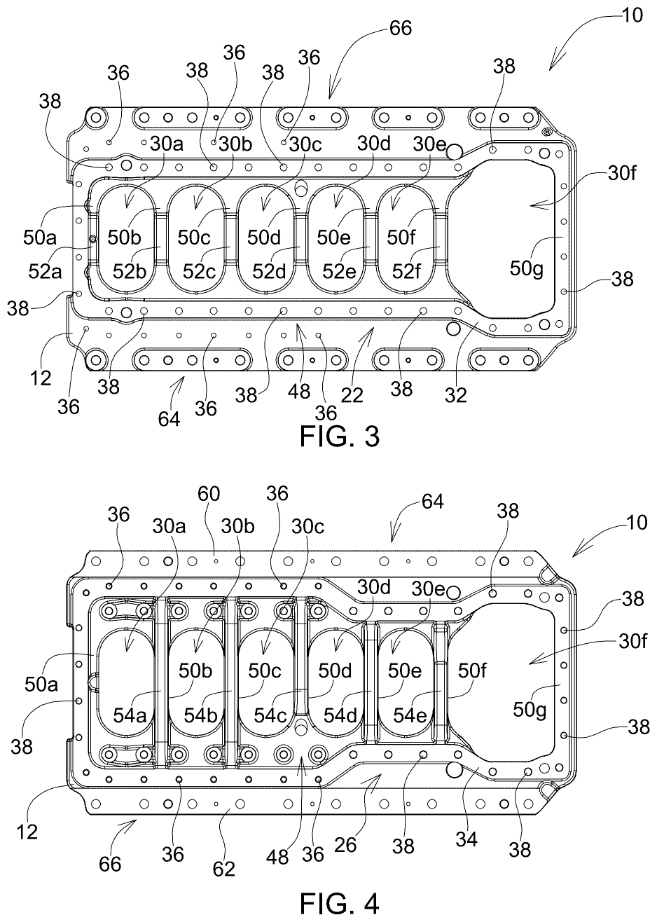

FIG. 1 shows a perspective view of an example embodiment of the engine support 10 according to the disclosure in the form of a sandwich plate 12. The sandwich plate 12 is furthermore shown in FIG. 2 in a lateral plan view and in FIGS. 3 and 4 in a plan view of a top side and a bottom side, respectively.

The expressions “top side” and “bottom side” relate here to the normal installation position of the sandwich plate 12 on the utility vehicle, in the present case an agricultural tractor (not illustrated).

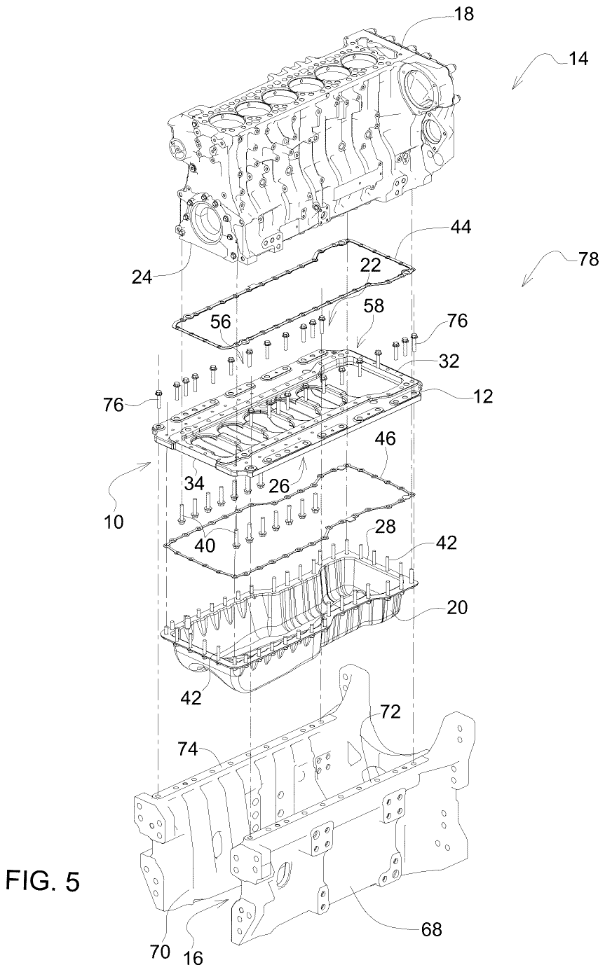

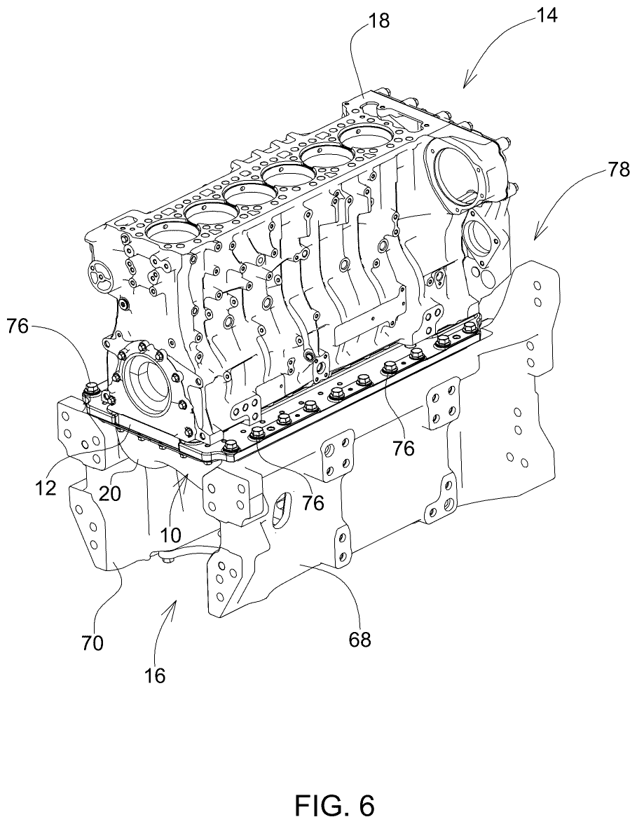

According to some embodiments, the engine support 10 or the sandwich plate 12 serves for the fastening of an internal combustion engine, in the form of a diesel engine 14, to a load-bearing vehicle structure 16 of the agricultural tractor according to FIGS. 5 and 6, wherein only an engine block 18 and an oil pan 20 of the diesel engine 14 are shown.

The sandwich plate 12, which is mountable or mounted on the load-bearing vehicle structure 16, comprises an upper fastening interface 22 for liquid-tight attachment of a separating surface 24 formed on the engine block 18, and comprises a lower fastening interface 26, situated opposite the upper fastening interface 22, for liquid-tight attachment of a separating surface 28 formed on the oil pan 20, wherein provision is made in the sandwich plate 12 of a multiplicity of apertures 30a, . . . , 30f for producing a lubricant connection between the oil pan 20 and the engine block 18. At the same time, these form corresponding free spaces for engine components which move in the direction of the oil pan 20 or undergo immersion and which are mounted within the engine block 18, such as for example connecting-rod-bearing bottom shells, counterweights provided on a crankshaft, or a drive wheel comprised by a lubricating-oil pump.

The upper and/or lower fastening interface 22, 26 is an upper or lower abutment surface 32, 34 which completely borders or annularly surrounds the apertures 30a, . . . , 30f and which is extended through by a multiplicity of threaded and passage bores 36, 38 for attachment of the engine block 18 and/or of the oil pan 20. For this purpose, alignment thereof with the respective separating surface 24, 28 on the engine block 18 or on the oil pan 20 is realized.

The threaded and passage bores 36, 38 serve for screwing of the engine block 18 and the oil pan 20 to the sandwich plate 12, or the oil pan 20 to the engine block 18 through the sandwich plate 12, by means of associated bolts 40, 42.

In the assembled state, seals 44, 46 provided between the abutment and separating surfaces 32, 24, 34, 28 of the engine block 18 and of the oil pan 20 prevent oil from escaping along the abutment or separating surfaces 32, 24, 34, 28 and also the threaded and passage bores 36, 38. Each of the areally formed seals 44, 46 has a contour which corresponds to the respective abutment or separating surface 32, 24, 34, 28. The threaded and passage bores 36, 38 are formed within the respective abutment surface 32, 34 in the form of a ring running around the apertures 30a, . . . , 30f.

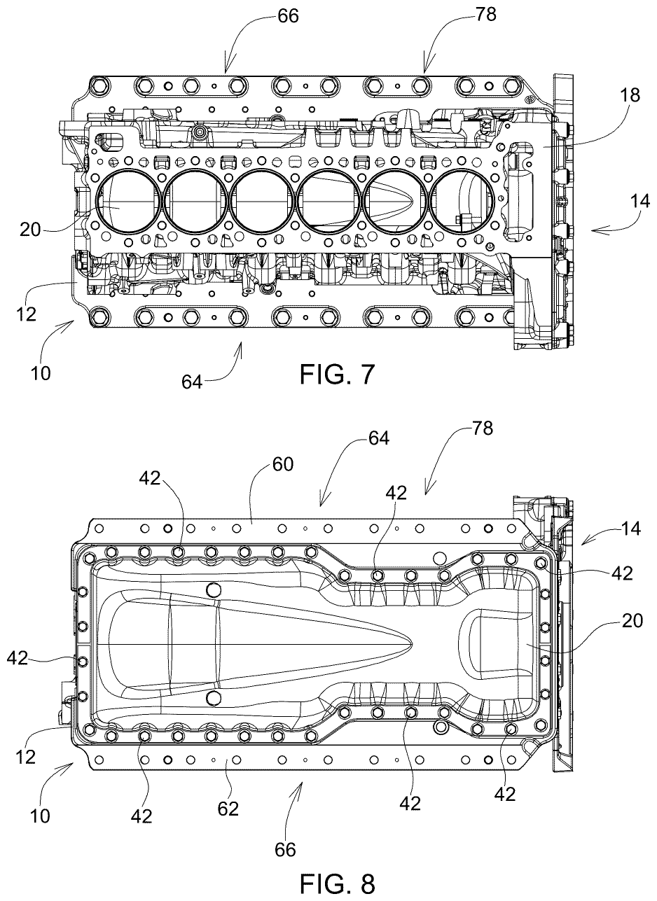

As can be seen on the basis of a comparison of FIG. 3 with FIG. 4, the abutment surfaces 32, 34, and thus the separating surfaces 24, 28 of the engine block 18 and the oil pan 20, have profiles which differ at least sectionally from one another. This makes it possible to optimize the dimensions of the oil pan 20 independently of the dimensions of the engine block 18 situated thereabove in terms of length and width in the context of accommodating the greatest possible oil volume (cf. FIGS. 7 and 8).

The apertures 30a, . . . , 30f form a web-like structure 48 which comprises a multiplicity of partially reinforced connecting ribs 50a, . . . , 50g. For reinforcement purposes, bead-like thickened portions 52a, . . . , 52f and 54a, . . . , 54e are formed along the upper and lower sides of the respective connecting ribs 50a, . . . , 50f.

The apertures 30a, . . . , 30e situated below a crankshaft region 56 of the engine block 18 have the form of transversely extending elongate holes. By contrast, the aperture 30f provided in a toothed-disk region 58 of the engine block 18 is larger and is delimited by the adjacent connecting ribs 50f, 50g and the inner contour of the upper abutment surface 32.

The sandwich plate 12 opens out into lateral bearing surfaces 60, 62 for mounting on the load-bearing vehicle structure 16. The lateral bearing surfaces 60, 62 are situated on opposite longitudinal sides 62, 64 of the sandwich plate 12, corresponding to the left-hand and right-hand vehicle sides, so that the sandwich plate 12 ultimately forms a connecting bridge between opposite side portions 68, 70 of the load-bearing vehicle structure 16. The attachment to the load-bearing vehicle structure 16 or left-hand and right-hand mounting surfaces 72, 74 formed thereon is realized in a rigid manner, for example by screw connection by means of associated bolts 76 without interposed rubber bearings or the like.

The sandwich plate 12 is a cast plate. The abutment or bearing surfaces 32, 34, 60, 62 are formed here by regions that are face-milled at a later stage. However, the sandwich plate 12 may, by contrast, also be a CNC-machined rolled-steel plate.

The engine support 10 or the sandwich plate 12 forms together with the engine block 18 attached to the upper fastening interface 22 and the oil pan 20 attached to the lower fastening interface 26 a self-contained, moreover particularly compact and rigid, engine structural unit 78. This can be pre-assembled, checked for tightness and correct functioning, and then installed into the agricultural tractor.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. An engine support for a utility vehicle, comprising:
a sandwich plate mountable on a load-bearing vehicle structure and having an upper fastening interface for liquid-tight attachment of a separating surface formed on an engine block and a lower fastening interface situated opposite the upper fastening interface for liquid-tight attachment of a separating surface formed on an oil pan, the sandwich plate including at least one aperture for producing a lubricant connection between the oil pan and the engine block.

2. The engine support of claim 1, wherein the upper fastening interface includes an upper abutment surface bordering the at least one aperture and the lower fastening interface includes a lower abutment surface bordering the at least one aperture, the upper and lower abutment surfaces include a plurality of threaded bores for attachment of the engine block and the oil pan.

3. The engine support of claim 2, wherein the upper and lower abutment surfaces have profiles which differ from one another.

4. The engine support of claims 1, wherein the at least one aperture includes a plurality of apertures forming a web-like structure.

5. The engine support of claim 4, wherein the web-like structure has a plurality of reinforced connecting ribs.

6. The engine support of claim 1, wherein the sandwich plate includes first and second lateral bearing surfaces situated on opposite longitudinal sides of the sandwich plate for mounting on a load-bearing vehicle structure.

7. The engine support of claim 1, wherein the sandwich plate is a cast plate.

8. An engine structural unit, comprising:
a sandwich plate mountable on a load-bearing vehicle structure and having an upper fastening interface and a lower fastening interface situated opposite the upper fastening interface;
an engine block having a separating surface in liquid-tight attachment to the upper fastening interface; and
an oil pan having a separating surface in liquid-tight attachment to the lower fastening interface, the sandwich plate including at least one aperture for producing a lubricant connection between the oil pan and the engine block.

9. The engine structural unit of claim 8, wherein the upper fastening interface includes an upper abutment surface bordering the at least one aperture and the lower fastening interface includes a lower abutment surface bordering the at least one aperture, the upper and lower abutment surfaces include a plurality of threaded bores for attachment of the engine block and the oil pan.

10. The engine structural unit of claim 9, wherein the upper and lower abutment surfaces have profiles which differ from one another.

11. The engine structural unit of claims 8, wherein the at least one aperture includes a plurality of apertures forming a web-like structure.

12. The engine structural unit of claim 11, wherein the web-like structure has a plurality of reinforced connecting ribs.

13. The engine structural unit of claim 8, wherein the sandwich plate includes first and second lateral bearing surfaces situated on opposite longitudinal sides of the sandwich plate for mounting on a load-bearing vehicle structure.

14. The engine structural unit of claim 8, wherein the sandwich plate is a cast plate.
